(19) United States
(12) Patent Application Publication
(10) Pub. No.: US 2017/0090108 A1
(43) Pub. Date: Mar. 30, 2017

(54) PLANAR ILLUMINATION DEVICE

(71) Applicant: Minebea Co., Ltd., Kitasaku-gun (JP)

(72) Inventors: Makoto FURUTA, Iwata (JP); Keito AZUMI, Konohana-ward (JP); Satoshi SUGAWARA, Kakegawa (JP)

(73) Assignee: Minebea Co., Ltd., Kitasaku-gun (JP)

(21) Appl. No.: 15/282,008

(22) Filed: Sep. 30, 2016

(30) Foreign Application Priority Data
Sep. 30, 2015 (JP) 2015-192606

(51) Int. Cl. F21V 8/00; F21V 19/00

(52) U.S. Cl. CPC G02B 6/0083; F21V 19/0025; F21Y 2105/00

(57) ABSTRACT

A planar illumination device according to an embodiment includes a light source, a circuit board and a pair of routing portions. The light source has a light emitting surface that emits light. The light source is mounted on the circuit board. A pair of land portions is provided on the circuit board, serves as a region where solder for electrically connecting respectively a pair of electrodes of the light source thereto is applied, is formed of an electrically conductive material, and corresponds to the electrodes. The pair of routing portions extends from each of the pair of land portions to at least a cover lay that protects a wiring on the circuit board and is formed of an electrically conductive material integrated with the land portions. First missing portions, being a region where the electrically conductive material is missing, are provided in each of the pair of routing portions.

### CROSS-REFERENCE TO RELATED APPLICATION(S)

The present application claims priority to and incorporates by reference the entire contents of Japanese Patent Application No. 2015-192606 filed in Japan on Sep. 30, 2015.

### BACKGROUND OF THE INVENTION

1. Field of the Invention

The present invention relates to a side light type planar illumination device.

2. Description of the Related Art

Conventionally, as a means of illumination of a liquid crystal display panel and the like, a side light type planar illumination device has been known in which light sources are arranged along the side end surface of the light guiding plate. In particular, a planar illumination device using a light emitting diode device (LED), which is small sized and excellent in environmental adaptability, as the light source, has been widely adopted, mainly in the field of small sized portable information devices, such as mobile phones.

In recent years, for an LED used for this type of planar illumination device, a technique has been proposed, in which electrode terminals are provided on side surfaces only, having no electrode terminals on the mounting surface of the main body of the LED (see, for example, Japanese Patent Application Laid-open No. 2014-107307). Such configuration having electrode terminals on the mounting surface is effective for reducing the height of LEDs and contributes to reduction in thickness of planar illumination devices.

However, difficulty of mounting for an LED without electrode terminals on the mounting surface will be remarkably increased. That is, as a result of not having electrode terminals on the mounting surface, a contact area between lands on a substrate and the electrode terminals will be decreased and connection failure upon connection of the LED to a substrate will be more likely to occur. This means that self alignment in a reflow process of a soldering material needs to be controlled with higher accuracy.

In order to downsize the planar illumination devices and perform mounting in the LEDs with higher density, while downsizing lands on substrates and the wirings around them, their strength needs to be secured.

The present invention has been made in view of the above, and an object thereof is to provide a planar illumination device which secures the strength of wirings while retaining the accuracy of the mounting of the light emitting elements.

### SUMMARY OF THE INVENTION

It is an object of the present invention to at least partially solve the problems in the conventional technology.

A planar illumination device according to an embodiment includes a light source, a circuit board and a pair of routing portions. The light source has a light emitting surface that emits light. The light source is mounted on the circuit board. A pair of land portions is provided on the circuit board, serves as a region where solder for electrically connecting respectively a pair of electrodes of the light source thereto is applied, is formed of an electrically conductive material, and corresponds to the electrodes. The pair of routing portions extends from each of the pair of land portions to at least a cover lay that protects a wiring on the circuit board and is formed of an electrically conductive material integrated with the land portions. First missing portions, being a region where the electrically conductive material is missing, are provided in each of the pair of routing portions.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a cross sectional diagram illustrating a schematic configuration of a planar illumination device;

FIG. 2 is an external view of a side view type LED, which is an example of a light source used in the planar illumination device;

FIG. 3 is an external view of the side view type LED, which is the example of the light source used in the planar illumination device;

FIG. 4 is a schematic perspective view illustrating how the light source is connected to land portions of a circuit board;

FIG. 5 is a diagram illustrating the land portions and a wiring pattern therearound, according to a first embodiment;

FIG. 6 is a diagram illustrating a state, where the light source has been arranged on the land portions in a swerved manner;

FIGS. 7A to 7F are diagrams illustrating a collection of examples of shapes of first missing portions;

FIGS. 8A to 8J are diagrams illustrating a collection of examples of shapes of second missing portions;

FIG. 9 is a diagram illustrating land portions and a wiring pattern therearound, according to a second embodiment; and

FIG. 10 is a diagram illustrating land portions and a wiring pattern therearound, according to a third embodiment.

### DETAILED DESCRIPTION OF THE PREFERRED EMBODIMENTS

Hereinafter, planar illumination devices according to embodiments of the present invention will be described in detail, with reference to the drawings. The present invention is not limited to the embodiments described below. Further, the drawings are schematic, and it needs to be noted that relative dimensions of each component and ratios among each components may be different from the actual ones. Further, a portion may be included, which has different dimensional relations and ratios among the drawings.

### First Embodiment

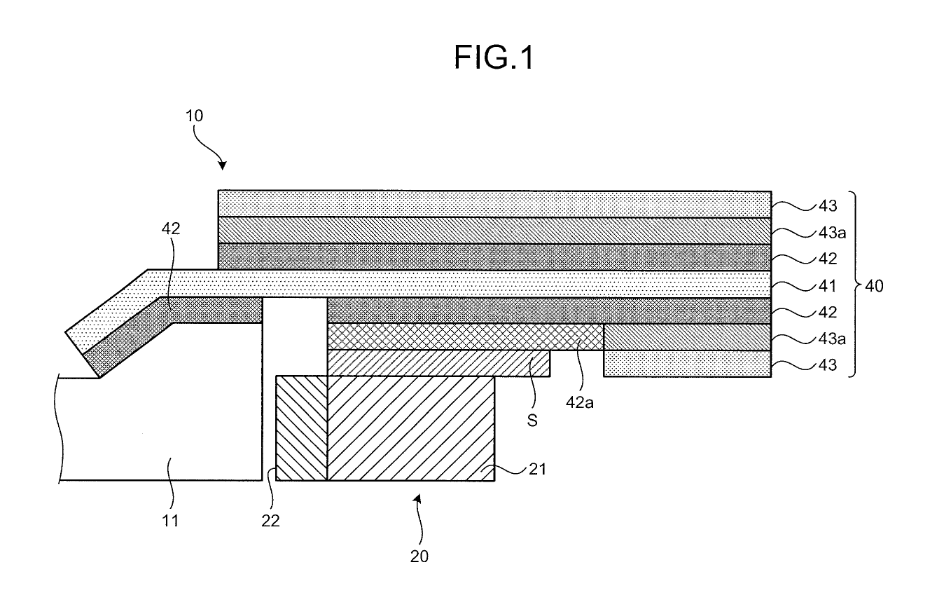

FIG. 1 is a cross sectional diagram illustrating a schematic configuration of a planar illumination device 10. As illustrated in FIG. 1, the planar illumination device 10 includes a light guiding plate 11, a light source 20, and a circuit board 40 on which the light source 20 is mounted. In general, the planar illumination device 10 includes a plurality of the light sources 20, but hereinafter, description will be made with a focus on one of the plurality of light sources 20. The same applies to a peripheral structure of the light source 20. It should be understood that the planar illumination device 10 includes, side by side, a plurality of the light source 20 and its peripheral structure described below.

The light guiding plate 11 is formed of a transparent material (for example, polycarbonate resin) in a rectangular shape in a top view thereof, and has an incidence plane, an end face to which a light emitting surface 22 of the light source 20 is to be opposed. The planar illumination device 10 is formed, such that light beams incident on the incidence plane of the light guiding plate 11 from the light source 20 repeat appropriate reflection in the light guiding plate 11, and the light guiding plate 11, which is rectangular shaped in the top view, appears as a light emitting body.

An example of a configuration of the circuit board 40 illustrated in FIG. 1 is a double sided flexible printed circuit board (FPC). The circuit board 40 has, as its basic configuration, a configuration having wiring layers 42 layered over both sides of a base film 41, and cover lays 43 layered further over the wiring layers 42 via adhesives 43a. However, as illustrated in FIG. 1, in a part of the circuit board 40, the part where an element, such as the light source 20, is connected to, the wiring layer 42 is not covered by the cover lay 43. On the wiring layer 42 of that part, a plated layer 42a is formed as a surface treatment. The wiring layers 42 and plated layer 42a are both formed of electrically conductive materials, and for example, the wiring layers 42 are formed of copper foil, and the plated layer 42a is formed by metal plating of tin, gold, or the like. A part, at which the plated layer 42a is applied on the wiring layer 42, and which is exposed from the cover lay 43, corresponds to land portions, which will be described in detail later, and terminals formed on a main body 21 of the light source 20 are connected to that part via solder S.

In an example of the configuration of the circuit board 40, a white film is preferably used as the base film 41. This is for efficiently reflecting the light beams emitted from the light source 20 and guiding more light beams to the light guiding plate 11. An example of a material suitable for formation of this base film 41 is white liquid crystal polymer. However, the white film is not limited to this example, and may be, for example, formed by a white member being applied on a film, such as polyimide. Further, the white member may also serve as the adhesive 43a that adheres the base film 41 and the wiring layer 42 together. The cover lay 43 is, for example, a film formed of polyimide or the like, but may be formed, for example, of a material also having a function as an adhesive member.

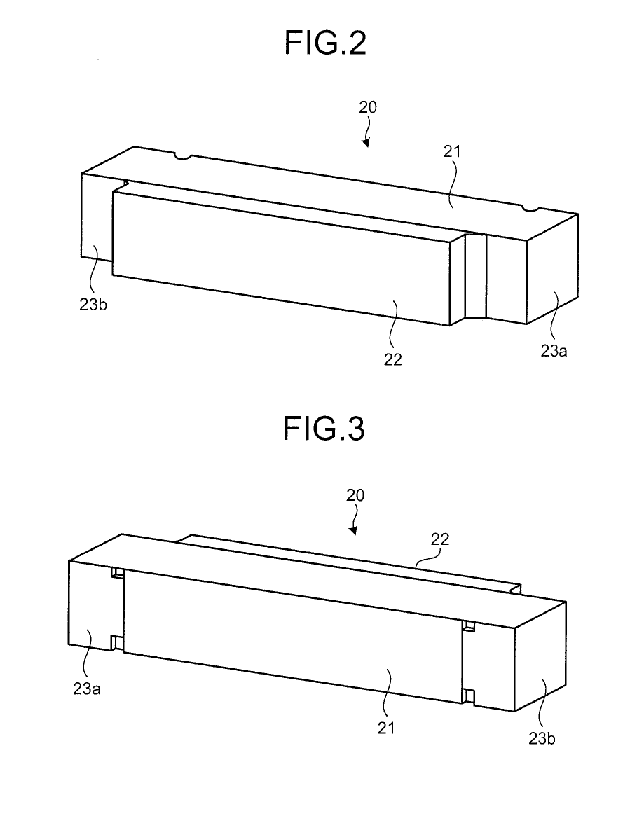

FIG. 2 and FIG. 3 are external views of a side view type LED, which is an example of the light source 20 used in the planar illumination device 10. FIG. 2 is an external perspective view as viewed from the light emitting surface 22 side, and FIG. 3 is an external perspective view as viewed from a reverse surface side.

As illustrated in FIG. 2 and FIG. 3, the light source 20 has a substantially cuboidal shape, includes the light emitting surface on one of longitudinal side surfaces of the main body 21, and has a pair of electrodes 23a and 23b on short side surfaces of the main body 21.

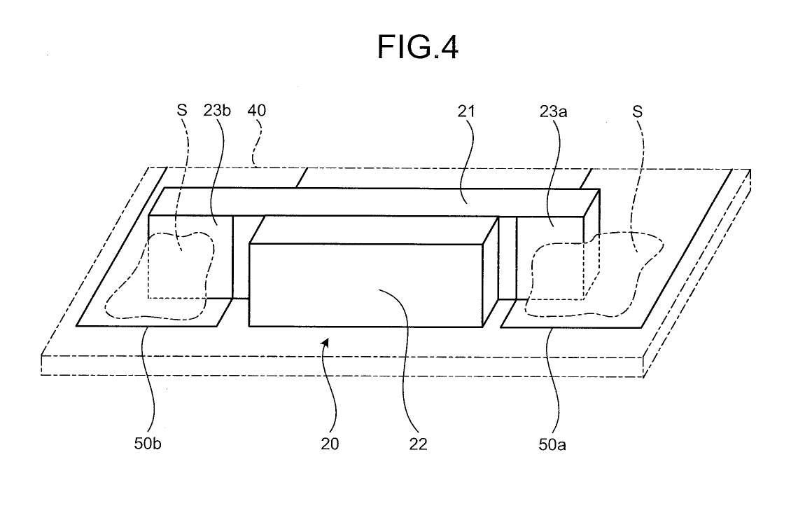

FIG. 4 is a schematic perspective view illustrating how the light source 20 is connected to the land portions of the circuit board 40. FIG. 4 is a schematic perspective diagram, and illustration is made with details omitted. In particular, as details of the land portions will be described in detail later, schematic shapes thereof are illustrated.

As illustrated in FIG. 4, the pair of electrodes 23a and 23b of the light source 20 are connected to a pair of land portions 50a and 50b, via the solder S. The pair of land portions 50a and 50b are formed at positions respectively corresponding to the pair of electrodes 23a and 23b provided in the main body 21 of the light source 20 when the light source 20 is mounted on the circuit board 40, and specifically, the first electrode 23a corresponds to the first land portion 50a, and the second electrode 23b corresponds to the second land portion 50b. Physical objects corresponding to the first and second land portions 50a and 50b are the wiring layer 42 and plated layer 42a exposed from the cover lay 43, which have been described with reference to FIG. 1. That is, the first and second land portions 50a and 50b are formed of the electrically conductive materials.

As illustrated in FIG. 4, the pair of electrodes 23a and 23b of the light source 20 are formed on the short side surfaces of the main body 21 of the light source 20. Therefore, when the light source 20 is mounted on the circuit board 40, the solder S connecting the pair of electrodes 23a and 23b to the pair of land portions 50a and 50b is applied to a range extending over to the short side surfaces of the main body 21 of the light source 20. Further, the light source 20 illustrated in the same figure is a side view type LED, and is arranged such that the light emitting surface 22 faces the side surface when the light source 20 is mounted on the circuit board 40.

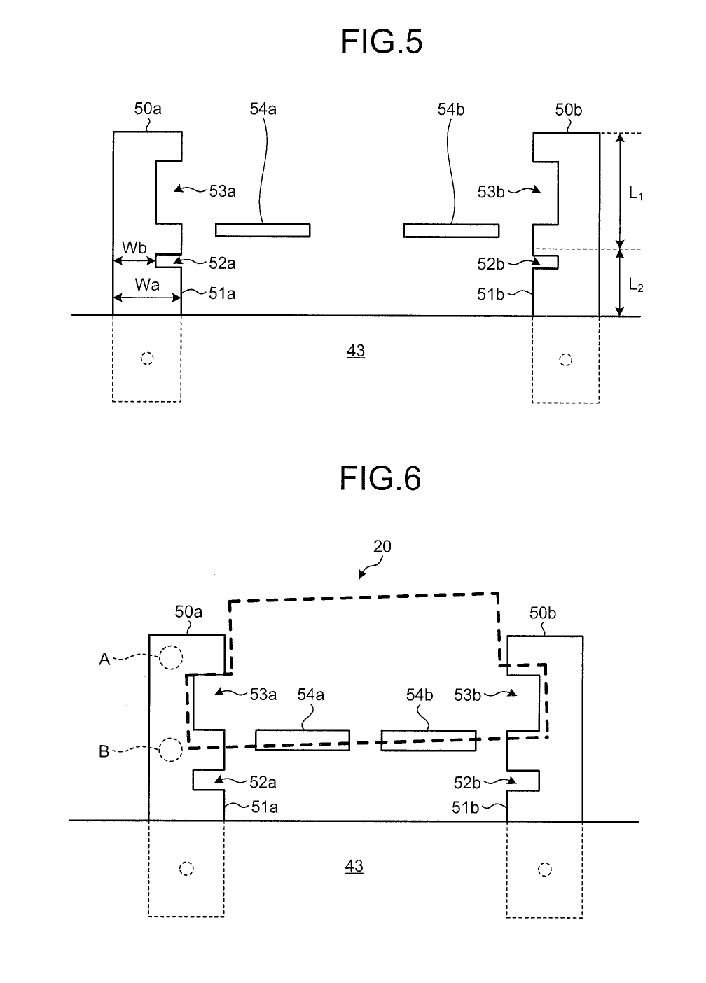

FIG. 5 is a diagram illustrating the land portions and a wiring pattern therearound, according to the first embodiment. As illustrated in FIG. 5, the land portions and the wiring pattern therearound according to the first embodiment have a wiring pattern that is bilaterally symmetrical. Therefore, illustration of bilaterally symmetrical components is omitted as appropriate for visibility of the figure.

As illustrated in FIG. 5, around the first and second land portions 50a and 50b, the first land portion 50a is formed integrally with a first routing portion 51a, and the second land portion 50b is formed integrally with a second routing portion 51b. The first and second land portions 50a and 50b and the first and second routing portions 51a and 51b are formed of the same electrically conductive materials, and cannot be clearly distinguished from each other physically. For ease of explanation, they will be distinguished from each other as follows. As can be seen from FIG. 1, FIG. 4 and FIG. 5, the first and second routing portions 51a and 51b and the light guiding plate 11 are in the opposite sides across the light source 20.

The first and second land portions 50a and 50b are an electrically conductive material serving as a region L₁, where solder for electrically connecting the electrodes 23a and 23b of the light source 20 thereto is applied. The first and second routing portions 51a and 51b are an electrically conductive material serving as a region L₂ extending from the region L₁ of the first and second land portions 50a and 50b to at least the cover lay 43. The region L₁, where the solder is applied, has individual difference. However, where to set boundaries between the first and second land portions 50a and 50b and the first and second routing portions 51a and 51b does not influence effects of the present invention.

As illustrated in FIG. 5, first missing portions 52a and 52b are respectively provided in the first and second routing portions 51a and 51b. The first missing portions 52a and 52b are regions where the electrically conductive material provided respectively in the first and second routing portions 51a and 51b is missing. The first missing portions 52a and 52b illustrated in FIG. 5 are rectangular notches respectively formed at side end portions of the first and second routing portions 51a and 51b, but as examples will be described later, the shapes of the first missing portions 52a and 52b are not limited to these shapes.

In the example of the configuration illustrated in FIG. 5, a width Wa of the first and second routing portions 51a and 51b at a boundary with the cover lay 43 is wider than a width Wb of narrow width portions of the first and second routing portions 51a and 51b, the narrow width portions formed by the first missing portions 52a and 52b. Therefore, strength of the first and second routing portions 51a and 51b at the boundary with the cover lay 43 is secured sufficiently. As a result, at the boundary with the cover lay 43, the boundary where stress is likely to be concentrated, risk of disconnection of the first and second routing portions 51a and 51b can be lessened.

As illustrated in FIG. 5, second missing portions 53a and 53b are respectively provided in the first and second land portions 50a and 50b. The second missing portions 53a and 53b are regions where the electrically conductive material provided respectively in the first and second land portions 50a and 50b is missing. The second missing portions 53a and 53b illustrated in FIG. 5 are rectangular notches respectively formed at side end portions of the first and second land portions 50a and 50b, but as examples will be described later, the shapes of the second missing portions 53a and 53b are not limited to these shapes.

As illustrated in FIG. 5, position checking marks 54a and 54b are formed between the first and second land portions 50a and 50b. These position checking marks 54a and 54b are for checking whether or not the position of the light source 20 is appropriate when the light source 20 is connected.

Next, with reference to FIG. 6, effects of the first missing portions 52a and 52b and second missing portions 53a and 53b will be described. FIG. 6 is a diagram illustrating a state where the light source 20 has been arranged in a swerved manner on the first and second land portions 50a and 50b.

As illustrated in FIG. 6, a state, where the light source 20 has been swerved downward in the figure at the first land portion 50a, is considered. A self alignment effect of solder applied near a region A is larger than a self alignment effect of solder applied near a region B. The self alignment effect is an effect of the position of the light source 20 being corrected by the surface tension of the solder in the reflow process or the like. As a result of the solder applied near the region B being dammed up by the first missing portion 52a, tension on an end portion of the light source 20 connected in the swerved manner is comparatively small. On the contrary, as a result of the solder applied near the region A being dammed up by the second missing portion 53a, tension on the end portion of the light source 20 connected in the swerved manner is comparatively large. As a result, the self alignment effect will work such that the end portion of the light source 20 connected in the swerved manner is corrected to an appropriate position.

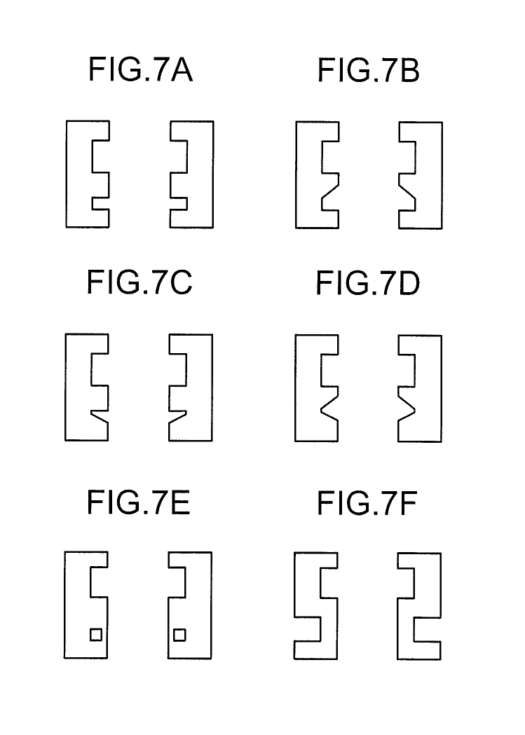

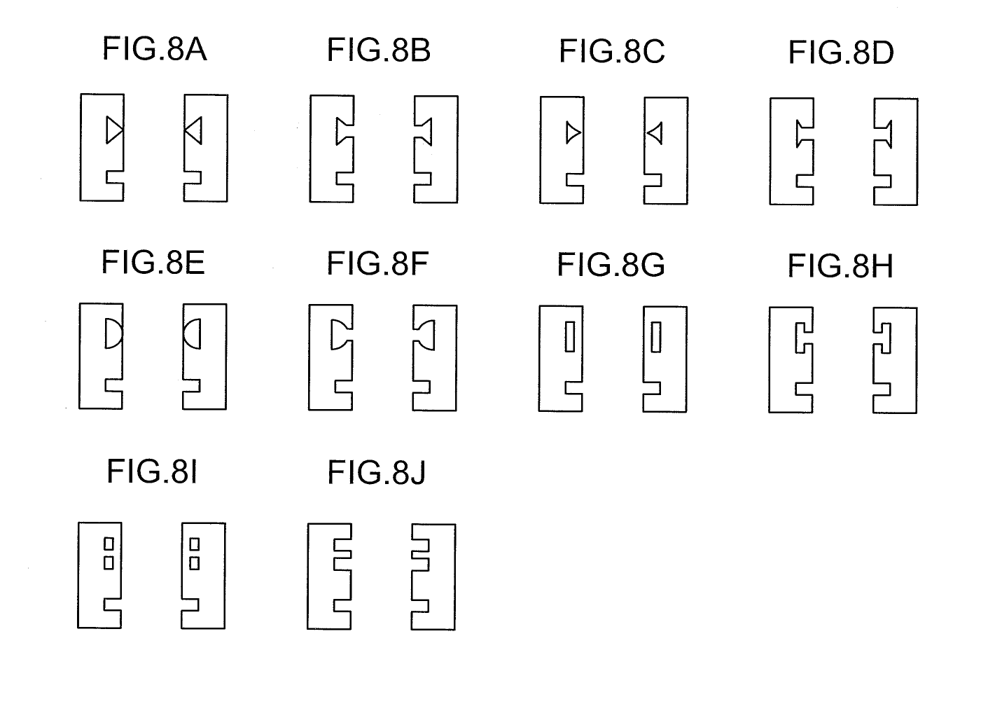

FIGS. 7A to 7F are diagrams illustrating a collection of examples of the shapes of the first missing portions, and FIGS. 8A to 8J are diagrams illustrating a collection of examples of the shapes of the second missing portions.

As illustrated in FIGS. 7A to 7F, the shapes of the first missing portions may be other than rectangular notches formed in the opposite side end portions of the routing portions. For example, like examples FIGS. 7B to 7D, the shape may be a notched shape in which at least one side of sides forming the notch is provided with a slope. Further, the first missing portion may be shaped as an opening like an example FIG. 7E. Furthermore, like an example FIG. 7F, the side end portions of the routing portions, the side end portions provided with the first missing portions, may be side end portions back to back with each other, rather than the side end portions facing each other.

As illustrated in FIGS. 8A to 8J, the shapes of the second missing portions may be other than the rectangular notches formed in the opposite side end portions of the routing portions. For example, like examples FIGS. 8A, 8C, 8E, 8G and 8I, the second missing portions may be shaped as openings, and as shapes of the openings, various shapes may be used, such as rectangles, triangles, and semicircles. Even when the second missing portions are shaped as notches, like examples FIGS. 8B, 8D, 8F, 8H, and 8J, for example, various shapes may be used.

### Second Embodiment

Hereinafter, a planar illumination device according to a second embodiment will be described, and the planar illumination device according to the second embodiment may have the same configuration as that of the first embodiment, except for a configuration of land portions and wirings therearound. Therefore, hereinafter, only the configuration of the land portions and wirings therearound according to the second embodiment will be described, and reference is made to the first embodiment with respect to the rest of the configuration.

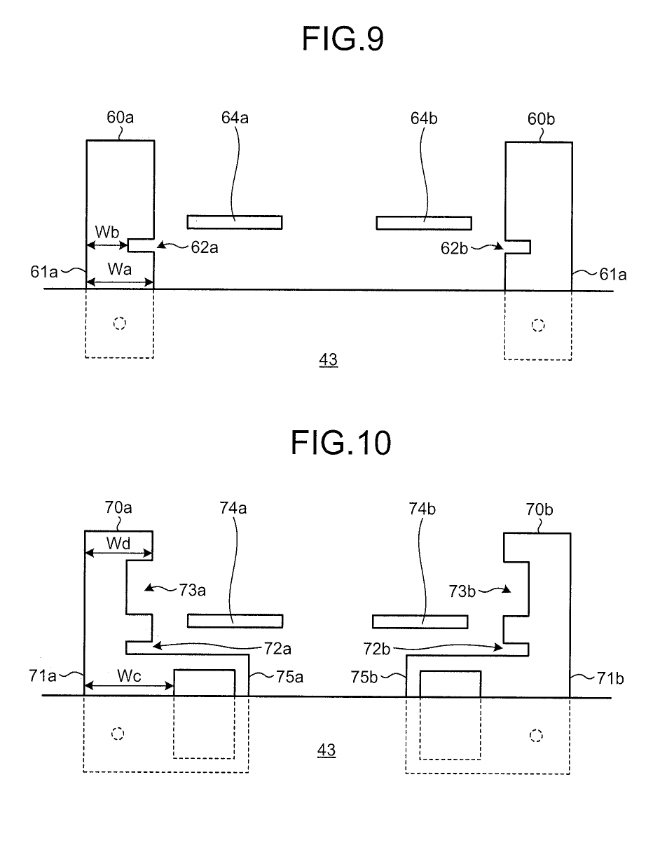

FIG. 9 is a diagram illustrating the land portions and the wiring pattern therearound, according to the second embodiment. As illustrated in FIG. 9, around the first and second land portions 60a and 60b, the first land portion 60a is formed integrally with a first routing portion 61a, and the second land portion 60b is formed integrally with a second routing portion 61b. The first and second land portions 60a and 60b and the first and second routing portions 61a and 61b are distinguished from each other similarly to those of the first embodiment.

As illustrated in FIG. 9, in the second embodiment, first missing portions 62a and 62b are formed in the first and second routing portions 61a and 61b only. The first missing portions 62a and 62b illustrated in FIG. 9 are rectangular notches formed in opposite side end portions of the first and second routing portions 61a and 61b, but they may be variously shaped like the collection of examples illustrated in FIGS. 7A to 7F.

Even for the first missing portions 62a and 62b of this configuration, a width Wa of the first and second routing portions 61a and 61b at a boundary with the cover lay 43 is wider than a width Wb of narrow width portions of the first and second routing portions 61a and 61b, the narrow width portions formed by the first missing portions 62a and 62b. Therefore, strength of the first and second routing portions 61a and 61b at the boundary with the cover lay 43 is secured sufficiently. As a result, at the boundary with the cover lay 43, the boundary where stress is likely to be concentrated, risk of disconnection of the first and second routing portions 61a and 61b can be lessened.

Further, even for the first missing portions 62a and 62b of this configuration, the effect of preventing the solder applied to the first and second land portions 60a and 60b from flowing out towards the first and second routing portions 61a and 61b is achieved. Therefore, even by this embodiment, the self alignment effect will work such that the end portion of the light source 20 connected in the swerved manner is corrected to an appropriate position.

In this embodiment also, position checking marks 64a and 64b are formed between the first and second land portions 60a and 60b. These position checking marks 64a and 64b are for checking whether or not the position of the light source 20 is appropriate when the light source 20 is connected.

### Third Embodiment

Hereinafter, a planar illumination device according to a third embodiment will be described, and the planar illumination device according to the third embodiment may have the same configuration as that of the first embodiment, except for a configuration of land portions and wirings therearound. Therefore, hereinafter, only the configuration of the land portions and wirings therearound according to the third embodiment will be described, and reference is made to the first embodiment with respect to the rest of the configuration.

FIG. 10 is a diagram illustrating the land portions and a wiring pattern therearound, according to the third embodiment. As illustrated in FIG. 10, around first and second land portions 70a and 70b, the first land portion 70a is formed integrally with the first routing portion 71a, and the second land portion 70b is formed integrally with the second routing portion 71b. The first and second land portions 70a and 70b and the first and second routing portions 71a and 71b are distinguished from each other similarly to those of the first embodiment.

As illustrated in FIG. 10, in the third embodiment, first missing portions 72a and 72b are formed in the first and second routing portions 71a and 71b, and second missing portions 73a and 73b are formed in the first and second land portions 70a and 70b. The first missing portions 72a and 72b illustrated in FIG. 10 are rectangular notches formed in opposite side end portions of the first and second routing portions 71a and 71b, but they may be variously shaped like the collection of examples illustrated in FIGS. 7A to 7F. The second missing portions 73a and 73b illustrated in FIG. 10 are rectangular notches formed in opposite side end portions of the first and second land portions 70a and 70b, but they may be variously shaped like the collection of examples illustrated in FIGS. 8A to 8J.

Auxiliary wirings 75a and 75b are respectively provided in the first and second routing portions 71a and 71b illustrated in FIG. 10. The auxiliary wirings 75a and 75b are for increasing reliability of the planar illumination device by ensuring electric conduction to the first and second land portions 70a and 70b even if any of the first and second routing portions 71a and 71b is disconnected. The auxiliary wirings 75a and 75b are preferably arranged in a region between the first routing portion 71a and second routing portion 72b. Although illustration is not made in FIG. 10, as described already, the planar illumination device parallelly includes a plurality of the light sources. Therefore, the auxiliary wirings 75a and 75b are preferably arranged in the region between the first routing portion 71a and second routing portion 72b in terms of the mounting density of the light sources in the planar illumination device.

In the example of the configuration illustrated in FIG. 10, a width We of the first and second routing portions 71a and 71b at a boundary with the cover lay 43 is wider than the maximum width Wd of the first and second land portions 70a and 70b. Therefore, strength of the first and second routing portions 71a and 71b at the boundary with the cover lay 43 is secured even more sufficiently. What is more, the auxiliary wirings 75a and 75b are provided in the first and second routing portions 71a and 71b in the example of the configuration illustrated in FIG. 10. Therefore, doubled reliability is ensured, in that not only is risk of disconnection of the first and second routing portions 71a and 71b can be lessened at the boundary with the cover lay 43, the boundary where stress is likely to be concentrated, but also electric conduction to the first and second land portions 70a and 70b can be ensured even if disconnection occurs in the first and second routing portions 71a and 71b.

In this embodiment also, position checking marks 74a and 74b are formed between the first and second land portions 70a and 70b. These position checking marks 74a and 74b are for checking whether or not the position of the light source 20 is appropriate when the light source 20 is connected.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A planar illumination device, comprising:
a light source having a light emitting surface that emits light;
a circuit board on which the light source is mounted;
a pair of land portions which is provided on the circuit board; which serves as a region where solder for electrically connecting a pair of electrodes of the light source is applied; which is formed of an electrically conductive material; and which corresponds to the electrodes; and
a pair of routing portions extending from each of the pair of land portions to a cover lay that protects at least a wiring on the circuit board and being formed of an electrically conductive material integrated with the pair of land portions, wherein
first missing portions, being regions where the electrically conductive material is missing, are provided in each of the pair of routing portions.

2. The planar illumination device according to claim 1, wherein the first missing portions are notches formed in side end portions of the pair of routing portions.

3. The planar illumination device according to claim 2, wherein the first missing portions are notches formed in opposite side end portions of the pair of routing portions.

4. The planar illumination device according to claim 2, wherein widths of the pair of routing portions at boundaries with the cover lay are wider than widths of narrow width portions of the pair of routing portions, the narrow width portions being formed by the notches.

5. The planar illumination device according to claim 2, wherein widths of the pair of routing portions at boundaries with the cover lay are wider than maximum widths of the land portions.

6. The planar illumination device according to claim 1, wherein the first missing portions are openings formed in the pair of routing portions.

7. The planar illumination device according to claim 1, wherein second missing portions, being regions where the electrically conductive material is missing, are provided in each of the pair of land portions.

8. The planar illumination device according to claim 7, wherein the second missing portions are notches formed in opposite side end portions of the land portions.

9. The planar illumination device according to claim 7, wherein the second missing portions are openings formed in the land portions.

10. The planar illumination device according to claim 1, further comprising a light guiding plate having an incidence plane, the incidence plane being an end face to which a light emitting surface of the light source is to be opposed.

11. The planar illumination device according to claim 1, wherein the pair of routing portions and a light guiding plate are in opposite sides across the light source.
